(19) United States
(12) Patent Application Publication
(10) Pub. No.: US 2022/0318598 A1
(43) Pub. Date: Oct. 6, 2022

(54) MACHINE LEARNING BASED INTERFERENCE WHITENER SELECTION

(71) Applicant: Samsung Electronics Co., Ltd., Suwon-si (KR)

(72) Inventors: Shailesh Chaudhari, San Diego, CA (US); Hyukjoon Kwon, San Diego, CA (US); Kee-Bong Song, San Diego, CA (US)

(21) Appl. No.: 17/339,752

(22) Filed: Jun. 4, 2021

Related U.S. Application Data
(60) Provisional application No. 63/168,545, filed on Mar. 31, 2021.

(51) Int. Cl. G06N 3/04; H04W 24/08; H04B 7/0413; H04B 7/08; H04L 5/00; G06F 17/16; G06N 3/08

(52) U.S. Cl. CPC G06N 3/0454; H04W 24/08; H04B 7/0413; H04B 7/08; H04L 5/0048; G06F 17/16; G06N 3/08

(57) ABSTRACT

A learning-based system and method for interference whitening method. In some embodiments, the method includes receiving a signal; extracting a first set of features from the signal; making a first selection, by a first neural network, based on the first set of features; and selecting a first covariance matrix, from a plurality of covariance matrices, based on the first selection.

### CROSS-REFERENCE TO RELATED APPLICATION(S)

The present application claims priority to and the benefit of U.S. Provisional Application No. 63/168,545, filed Mar. 31, 2021, entitled “MACHINE LEARNING BASED INTERFERENCE WHITENER SELECTION”, the entire content of which is incorporated herein by reference.

### FIELD

One or more aspects of embodiments according to the present disclosure relate to wireless communications, and more particularly to a learning-based system and method for interference whitening.

### BACKGROUND

In a wireless communication system (e.g., a 5G mobile communications system), interference may be a potentially important source of errors in transmitted data. Interference whitening may be used as part of a process for mitigating the effects of interference. An interference whitener may whiten the spatial domain interference and noise by pre-multiplying the received signal vector and channel matrix with the Cholesky factorization of a covariance matrix, which may be selected from among a plurality of candidate covariance matrices.

The covariance matrix corresponding to the lowest error rate may depend on the signal-to-interference ratio (SIR), the distribution of interference in the bandwidth part (BWP), the signal-to-noise ratio (SNR), and other factors. However, in practice, the SIR, and the distribution of interference in the BWP may be unknown at the receiver.

Thus, there is a need for an improved system and method for interference whitening.

### SUMMARY

According to an embodiment of the present disclosure, there is provided a method, including: receiving a signal; extracting a first set of features from the signal; making a first selection, by a first neural network, based on the first set of features; and selecting a first covariance matrix, from a plurality of covariance matrices, based on the first selection.

In some embodiments, the making of the first selection by the first neural network includes making the first selection based on a plurality of initial covariance estimates, each corresponding to a respective resource block (RB) of a contiguous set of resource blocks.

In some embodiments, the contiguous set of resource blocks includes all of the resource blocks in a bandwidth part.

In some embodiments, the method further includes: extracting a second set of features from the signal; and making a second selection, by a second neural network, based on the second set of features, wherein the first set of features corresponds to a first resource block, and the second set of features corresponds to a second resource block.

In some embodiments: the first selection is an indication of estimated signal to interference ratio in the first resource block; the first selection corresponds to a signal to interference ratio less than a first threshold; and the selecting of the first covariance matrix includes selecting a covariance matrix based on a first initial covariance estimate, the first initial covariance estimate corresponding to the first resource block.

In some embodiments: the first selection is an indication of estimated signal to interference ratio in the first resource block; the first selection corresponds to a signal to interference ratio greater than a first threshold; the second selection is an indication of estimated signal to interference ratio in the second resource block; the second selection corresponds to a signal to interference ratio greater than the first threshold; the selecting of the first covariance matrix includes selecting a covariance matrix based on a first initial covariance estimate and on a second initial covariance estimate; the first initial covariance estimate corresponds to the first resource block; and the second initial covariance estimate corresponds to the second resource block.

In some embodiments, the method further includes calculating a first initial covariance estimate, wherein a first feature of the first set of features is based on the first initial covariance estimate.

In some embodiments, the first feature includes an eigenvalue of the first initial covariance estimate.

In some embodiments, the first feature includes a QR decomposition of the first initial covariance estimate.

In some embodiments, the first feature includes an element of the first initial covariance estimate.

According to an embodiment of the present disclosure, there is provided a device, including: a radio; and a processing circuit, the processing circuit being configured to: receive, through the radio, a signal; extract a first set of features from the signal; make a first selection, by a first neural network, based on the first set of features; and select a first covariance matrix, from a plurality of covariance matrices, based on the first selection.

In some embodiments, the making of the first selection by the first neural network includes making the first selection based on a plurality of initial covariance estimates, each corresponding to a respective resource block (RB) of a contiguous set of resource blocks.

In some embodiments, the contiguous set of resource blocks includes all of the resource blocks in a bandwidth part.

In some embodiments, the processing circuit is further configured to: extract a second set of features from the signal; and make a second selection, by a second neural network, based on the second set of features, wherein the first set of features corresponds to a first resource block, and the second set of features corresponds to a second resource block.

In some embodiments: the first selection is an indication of estimated signal to interference ratio in the first resource block; the first selection corresponds to a signal to interference ratio less than a first threshold; and the selecting of the first covariance matrix includes selecting a covariance matrix based on a first initial covariance estimate, the first initial covariance estimate corresponding to the first resource block.

In some embodiments: the first selection is an indication of estimated signal to interference ratio in the first resource block; the first selection corresponds to a signal to interference ratio greater than a first threshold; the second selection is an indication of estimated signal to interference ratio in the second resource block; the second selection corresponds to a signal to interference ratio greater than the first threshold; the selecting of the first covariance matrix includes selecting a covariance matrix based on a first initial covariance estimate and on a second initial covariance estimate; the first initial covariance estimate corresponds to the first resource block; and the second initial covariance estimate corresponds to the second resource block.

According to an embodiment of the present disclosure, there is provided a device, including: a radio; and means for processing, the means for processing being configured to: receive, through the radio, a signal; extract a first set of features from the signal; make a first selection, by a first neural network, based on the first set of features; and select a first covariance matrix, from a plurality of covariance matrices, based on the first selection.

In some embodiments, the making of the first selection by the first neural network includes making the first selection based on a plurality of initial covariance estimates, each corresponding to a respective resource block (RB) of a contiguous set of resource blocks.

In some embodiments, the contiguous set of resource blocks includes all of the resource blocks in a bandwidth part.

In some embodiments, the means for processing is further configured to: extract a second set of features from the signal; and make a second selection, by a second neural network, based on the second set of features, wherein the first set of features corresponds to a first resource block, and the second set of features corresponds to a second resource block.

### BRIEF DESCRIPTION OF THE DRAWINGS

These and other features and advantages of the present disclosure will be appreciated and understood with reference to the specification, claims, and appended drawings wherein:

FIG. 1A is a block diagram of a system for interference whitening, according to an embodiment of the present disclosure;

FIG. 1B is a block diagram of a system for interference whitening, according to an embodiment of the present disclosure;

FIG. 1C is a block diagram of a system for interference whitening, according to an embodiment of the present disclosure;

FIG. 2 is a block diagram of a method for label generation, according to an embodiment of the present disclosure;

FIG. 3 is a block diagram of a neural network, according to an embodiment of the present disclosure;

FIG. 4A is a graph of simulation results, according to an embodiment of the present disclosure;

FIG. 4B is a graph of simulation results, according to an embodiment of the present disclosure;

FIG. 4C is a graph of simulation results, according to an embodiment of the present disclosure;

FIG. 4D is a graph of simulation results, according to an embodiment of the present disclosure; and

FIG. 5 is a flowchart of a portion of a learning-based method for interference whitening, according to an embodiment of the present disclosure.

### DETAILED DESCRIPTION

The detailed description set forth below in connection with the appended drawings is intended as a description of exemplary embodiments of a learning-based system and method for interference whitening provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In a multiple input multiple output (MIMO) 5G receiver, (e.g., in a user equipment (UE)), interference whitening may be performed to improve performance in the presence of interference, which in most circumstances is not white. As used herein, the phrase “user equipment” is used as a countable noun even though the noun it contains (“equipment”) may not be countable in ordinary English.

In some embodiments, a machine-learning-based (or “learning-based”) method is employed to select an interference whitener (IW) for each resource block (RB) within the bandwidth part (BWP) of the received signal on a MIMO receiver. In a 5G network, the interference whitener may be selected based on input features derived from reference symbols, for example, demodulation reference symbols (DMRSs). A covariance matrix for the interference whitening may then be selected, directly or indirectly (as discussed in further detail below) by a neural network (e.g., multi-layer perceptron (MLP) network), from a predefined set of candidate covariance matrices. The interference whitener may whiten the spatial domain interference and noise by pre-multiplying the received signal vector and channel matrix with the Cholesky factorization of the selected covariance matrix. The use of an appropriate covariance matrix for whitening may result in a reduced error rate.

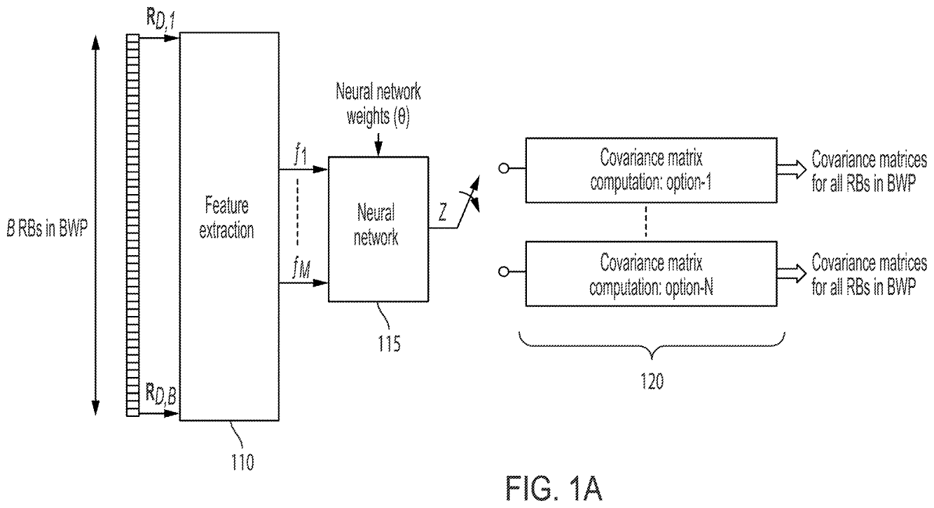

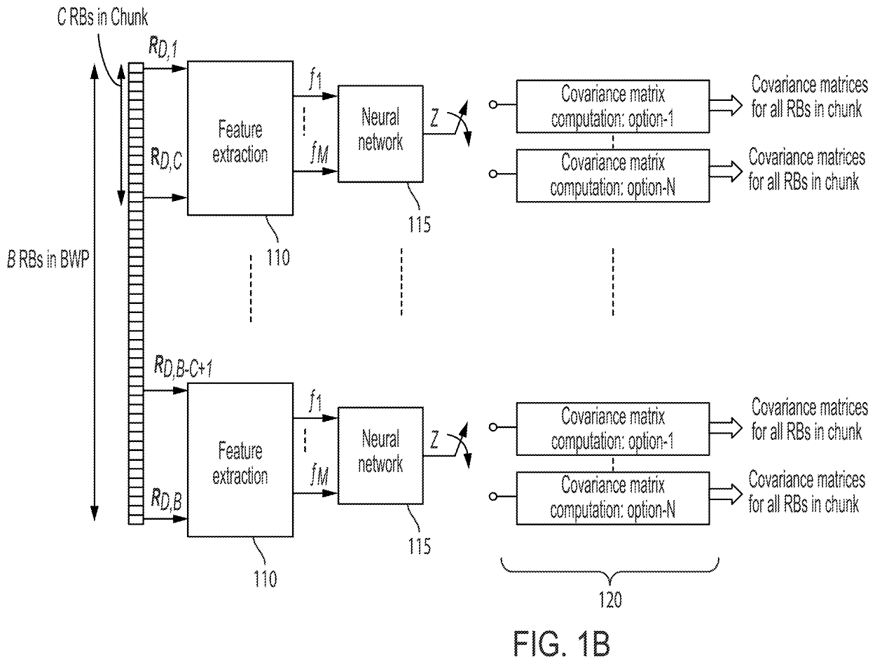

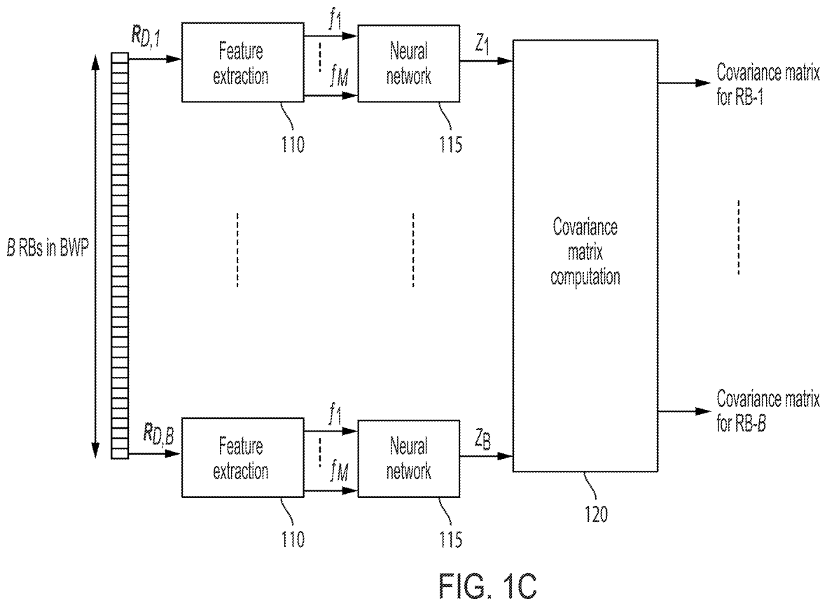

Referring to FIG. 1A, in some embodiments, three blocks may be employed in the process of selecting a covariance matrix for whitening: (i) a feature extraction block (or “input feature extraction block”) 110 which extracts input features from DMRSs, (ii) a neural network 115, which uses the set of extracted input features and provides an output indicating how to compute the covariance matrix for whitening, and (iii) a covariance matrix computation block 120, which computes the covariance matrix based on the neural network's output. In some embodiments, this approach may make it possible for each contiguous set of RBs (e.g., each “RB chunk”) in each slot to use a different covariance matrix for interference whitening, depending on SIR, SNR and interference distribution in the BWP. As used herein, a “set of features” means one or more features and a “set of features” may be a single feature.

The system may operate in one of three modes, which may be referred to as “per BWP” (illustrated in FIG. 1A), “per RB chunk” (illustrated in FIG. 1B), or “per RB” (illustrated in FIG. 1C). In per BWP mode, the system may perform feature extraction and neural network inference (or “selection” or “classification”) once per BWP; in per RB chunk mode, the system may perform feature extraction and neural network inference once per RB chunk, and in per RB mode, the system may perform feature extraction and neural network inference once per RB. As mentioned above, FIG. 1A shows a configuration that may be employed in per BWP mode, FIG. 1B shows a configuration that may be employed in in per RB chunk mode, and FIG. 1C shows a configuration that may be employed in per RB mode.

The feature extraction block 110 may use as input received signal vectors, pilots, and channel matrices that are (i) in per BWP mode, from DMRS locations in the BWP, (ii) in per RB chunk mode, from DMRS locations in the RB chunk, and (iii) in per RB mode, from DMRS locations in the RB.

Interference may not be present in each RB. Letting: (i) B be the total number of resource blocks (RBs) in the bandwidth part (BWP) (ii) C be the number of RBs in one RB chunk when per RB chunk mode is employed, (iii) S_{I} be the set of RBs containing interference (such that the set S_{I} indicates the interference distribution in the BWP, e.g., which RBs within BWP have interference), and (iv) S_{b} be the set of REs in the b-th RB, the received signal at the UE in the n-th RE may be written as:

$${y}_{n} = \{ \begin{matrix}{H}_{n} {x}_{n} + {H}_{I , n} {x}_{I , n} + {w}_{n} , & if n ∈ {S}_{b} and b ∈ {S}_{I} \\ {H}_{n} {x}_{n} + {w}_{n} , & otherwise ,\end{matrix} \qquad ( 1 )$$

where wₙ is the noise vector.

The input feature extraction block 110 may first compute an initial covariance estimate based on the received signal vector yₙ, channel Hₙ and transmitted pilot xₙ in the DMRS REs as follows:

$${R}_{D , b} = \frac{1}{\vert {S}_{D , b} \vert} {\sum }_{n ∈ {S}_{D , b}} [ ( {y}_{n} - {H}_{n} {x}_{n} ) {( {y}_{n} - {H}_{n} {x}_{n} )}^{*} ] , \qquad ( 2 )$$

where S_{D,b} is the set of DMRS resource elements (REs) in the b-th RB and |S_{D,b}| is the cardinality of the set. The input feature extraction block 110 may (as discussed in further detail below) generate one or more features f₁, f₂, f₃, . . . from R_{D,b}.

In per BWP mode and in per RB chunk mode, the neural network may provide an output z∈{1, 2, . . . N} to select, from among N methods (or “method options”) referred to herein as Option-1, 2, . . . or N, a method for computing the covariance matrix used for interference whitening, which may be referred to herein as R_{IW,b}. For N=4, the options may include (without being limited to) the following:

$$Option - 1 : {R}_{IW , b} = diag \{ {R}_{D , b} \}$$

$$Option - 2 : {R}_{IW , b} = diag \{ \frac{1}{B} {\sum }_{b} {R}_{D , b} \}$$

$$Option - 3 : {R}_{IW , b} = {R}_{D , b}$$

$$Option - 4 : {R}_{IW , b} = \frac{1}{B} {\sum }_{b} {R}_{D , b}$$

where diag{A} is a diagonal matrix having the same diagonal elements as the matrix A. The options identified as Option-1 through Option-4 are arranged, above, in ascending order of complexity (when the calculating of the inverse of the Cholesky factorization is taken into account). Thus, Option-1 has the least complexity. For example, the complexity of Option-3 (which does not require any calculations to determine R_{IW,b} from R_{D,b}) may be greater than the complexity of Option-2 because the complexity of the calculating of the inverse of the Cholesky factorization may be low, in Option-2, in which R_{IW,b} is diagonal.

Referring to FIG. 1C, in per RB mode, feature extraction and neural network inference is performed separately for each RB, as shown. In this mode, each neural network provides an output value z_{b}∈{1, 2, . . . N} to indicate the SIR level in RB-b (instead of directly identifying a method for calculating the covariance matrix to be used for interference whitening, as is the case in per BWP mode and in per RB chunk mode), where z_{b}=1 indicates very low SIR, while z_{b}=N indicates very high SIR. Intermediate values of z_{b} (i.e., z_{b}>1, z_{b}<N) may indicate intermediate levels of SIR. The covariance matrix computation block 120 may receive an output value from each of the neural networks 115 and, based on the output values, select a method (e.g., from the methods Option-1 through Option-4 identified above) to be used to calculate a respective covariance matrix to be used for interference whitening each of the RBs. The covariance matrix for each of the RBs, RB-1, 2, . . . , B, may then be computed using the selected method. The rule employed by the covariance matrix computation block 120 to select the method may take into account the SIR levels z_{b} provided by the neural network. An example of a rule for selecting a method for computing the covariance matrices is the following:

IF any z_{b}=1 for b=1, 2, . . . B

Compute R_{IW,b} with option i for all b=1, 2, . . . , B

### Else

Compute R_{IW,b} with option j for all b=1, 2, B

where options i and j (each of which is an index identifying a method, with e.g., the index value 1 identifying Option-1, the index value 2 identifying Option-2, and so forth) may be found using Equation (4) below. For example, if the SIR is low (e.g., if z_{b}=1, or more generally, less than a first threshold) in one of the RBs, then a method option (e.g., Option-3) which does not average together the initial covariance estimates may be employed. Otherwise, a method option that combines multiple initial covariance estimates, such as Option-2 or Option-4, may be employed.

As such, in the per BWP mode and in the per RB chunk mode, the neural network 115 may make a first selection (the selection being an output value identifying a method option), and a first covariance matrix may then be calculated based on this first selection (or, equivalently, the first covariance matrix may be said to be selected (from the plurality of covariance matrices corresponding to the plurality of method options) based on the first selection). Similarly, in the per RB mode, a first neural network 115, corresponding to a first RB, may make a first selection (the selection being an output value corresponding to an estimated SIR for the first RB), and a first covariance matrix may be selected based on the first selection (and based also on the selections made by the other neural networks 115).

Offline training to determine the neural network parameters (θ) may be performed using a method including the following steps:

1. Generation of a labeled dataset.

2. Selection of input features.

3. Neural network training.

In order to train the neural network, first a labeled dataset is generated; this may be performed as follows. Two label generation methods may be employed. For the per BWP and per RB chunk modes, the labels may be generated based on the instantaneous CRC flag, e.g., based on the instantaneous decoding result. For the per RB mode, the labels may be generated based on the average of the CRC flag, e.g., based on the average of the decoding result.

The labeled dataset consists of a tuple containing features f₁, f₂, . . . and label z E {1, 2 . . . N}. Each tuple corresponds to one BWP at a specific scenario of SNR, SIR, interference distribution in BWP, modulation order, and code rate. A simulation (using pseudorandom noise and interference) may be used to generate simulated received signals, and to simulate the processing of the signal after simulated application of an interference whitening filter. To generate the labeled data, each method option 1, 2, . . . N is used for whitening for each BWP. After interference whitening, the signal is detected and decoded.

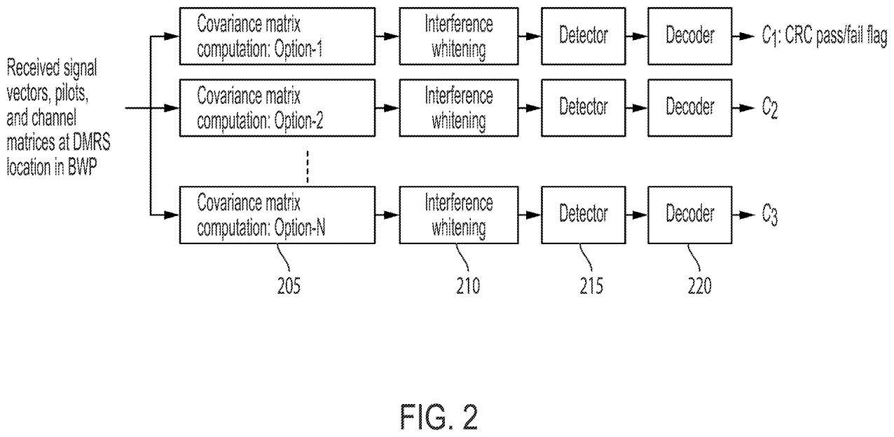

FIG. 2 shows a process of testing (e.g., in simulation) the different selections each neural network may make when performing inference, for a given data sample, to determine which selection result in the best performance; this selection may then be used to label the data sample. The inputs may be fed to a plurality of covariance matrix computation blocks 205, each of which uses a different respective method to calculate a respective covariance matrix. Each of the covariance matrices may then be used to perform interference whitening in a respective interference whitening block 210. The output of each interference whitening block 210 may be fed through a respective detector 215 to a respective decoder 220, which may generate a pass/fail flag to indicate whether decoding was successful. For the per BWP and per RB chunk modes, the labels may be generated based on the CRC pass/fail flag in each slot; the label z may be the option number of the lowest complexity method for which the CRC flag passes. The label can be expressed as

$$z = {min}_{n} \{ n \vert {c}_{n} = 1 \} \qquad ( 3 )$$

where cₙ∈{0,1} is the cyclic redundancy check (CRC) pass/fail flag generated by the decoder if Option-n is used for whitening.

For the per RB mode, the labels may be generated based on the average of the CRC flag. Letting c̅ₙ be the average of CRC flag with option-n over multiple channel realizations, the labels may be generated as follows

z_{b}=i, where c̅ᵢ≥c̅ₙ, ∀n≠i at very low SIR

z_{b}=j, where c̅ⱼ≥c̅ₙ, ∀n≠j at no interference (very high SIR) scenario (4)

According to Equation (4), one rule may be employed (e.g., selecting method option Option-3) when at least one RB is at low SIR, and another rule (e.g., selecting method option Option-2 or method option Option-4) may be employed when all of the RBs are at relatively high SIR.

Feature generation may be performed as follows. Features may be generated to capture different scenarios specified by the interference distribution in the BWP, the SIR, and the SNR. The features may be extracted from the elements of R_{D,b} and from the modulation and coding scheme. Examples of features that may be extracted from R_{D,b} include (without being limited to) (i) eigenvalues of R_{D,b}, (ii) the QR decomposition of R_{D,b}, (iii) diagonal and non-diagonal elements of R_{D,b}, and (iv) combinations thereof.

Input feature selection may then be performed as follows. For the training of the neural network, a subset of all available features may be used, the subset being selected to contain the features that are most informative (or relevant) regarding the label z. The most informative features may be found using mutual information between the label z and features fᵢ. These selected features may then be selected by the input feature extraction block 110.

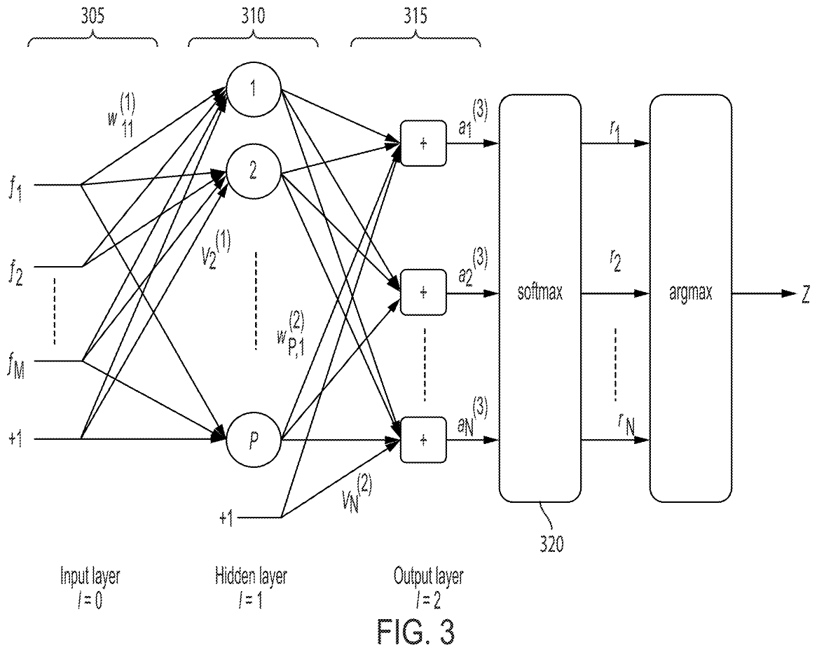

Neural network training may be performed to obtain the network parameter θ. The network parameter θ includes (e.g., consists of) weights wᵢⱼ^{(l)} and biases vᵢ^{(l)}. A neural network with an input layer 305, one hidden layer 310 having P nodes, and an output layer 315, as illustrated in FIG. 3, may be employed. Each hidden node may use a sigmoid activation function. The output of the network may be computed by applying a softmax function 320 on the output layer 315, which may include (e.g., consist of) D nodes. As used herein, the symbol wᵢⱼ^{(l)} may indicate the weight between the j-th node in layer l−1 and the i-th node in layer l. The output of the node i in layer l=2 is

$${a}_{i}^{( 2 )} = g ( {\sum }_{j} {w}_{ij}^{( 1 )} {f}_{j} + {v}_{i}^{( 1 )} ) , i = 1 , 2 , … , P , \qquad ( 5 )$$

where

$$g ( x ) = \frac{1}{1 + {e}^{- x}}$$

is the sigmoid activation function and vᵢ⁽¹⁾ is the bias term. The output of node i in layer l=3 is

aᵢ⁽³⁾)=Σⱼwᵢⱼ⁽²⁾aⱼ⁽²⁾+vᵢ⁽²⁾,i=1,2, . . . ,D. (6)

Finally, the output of the network may be computed by applying softmax on {a₁⁽³⁾, a₂⁽³⁾, . . . , a_{N}⁽³⁾} as follows

$${r}_{i} = \frac{{e}^{{a}_{i}^{( 3 )}}}{{\sum }_{j} {e}^{{a}_{j}^{( 3 )}}} , i = 1 , 2 , … , N . \qquad ( 7 )$$

In order to obtain weight and bias terms {wᵢⱼ^{(l)}, vᵢ^{(l)}} and hence the network parameter θ, the neural network may be trained using a quasi-Newton algorithm to minimize the following cross-entropy cost function

c(θ)=C(wᵢⱼ^{(l)},vᵢ^{(l)})=−Σₖ₌₁^{K}Σᵢ₌₁^{N}I(i=zₖ)log(r_{i,k}), (8)

where I(i=zₖ) is an identity function (1 if i=zₖ, and 0 otherwise), zₖ in the label in the k-th training tuple, r_{i,k} is the MLP output corresponding to the k-th training sample, and K is the total number of training samples. Once training has been performed and the network parameter θ has been obtained, learning-based selection of a covariance matrix for whitening may be performed as illustrated in FIGS. 1A-1C.

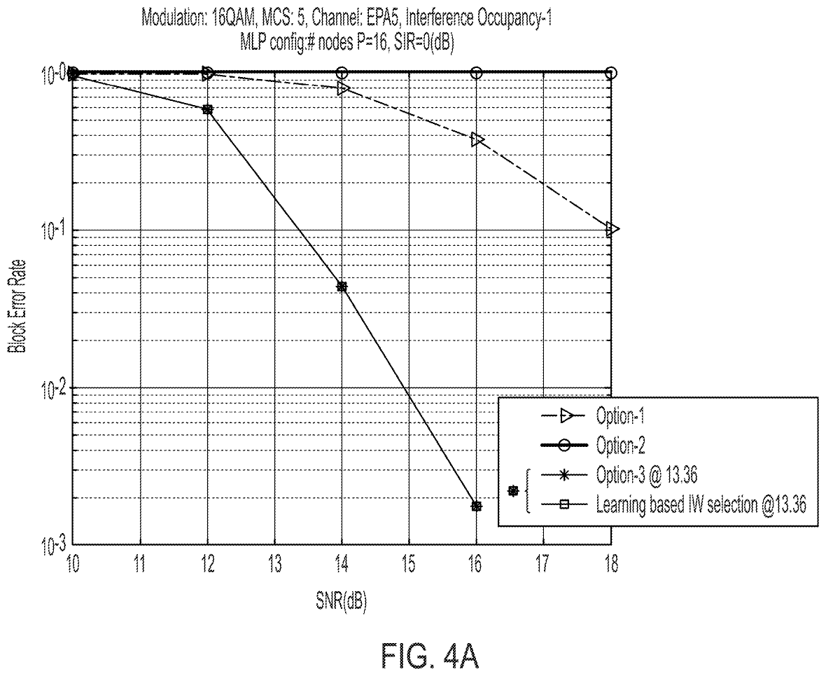

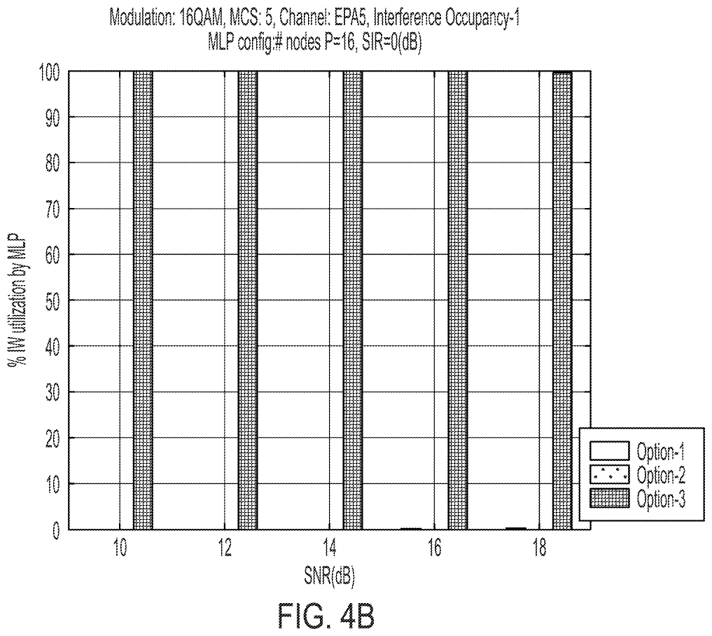

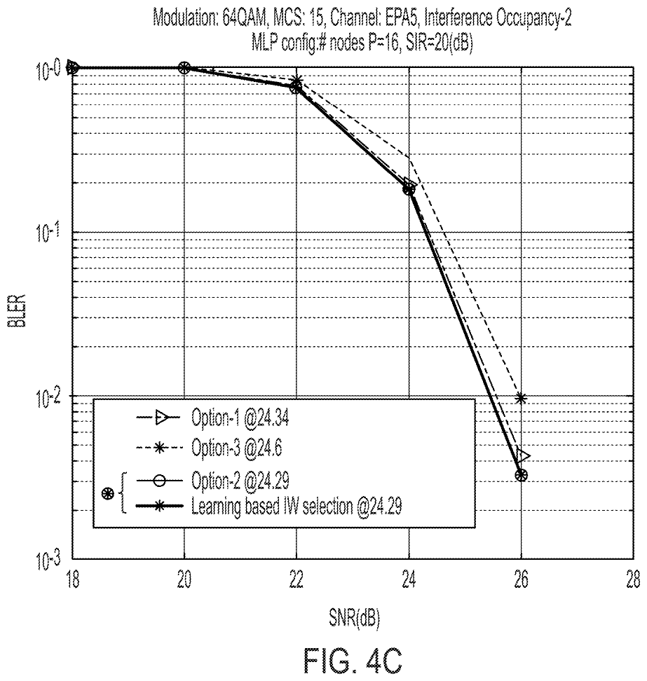

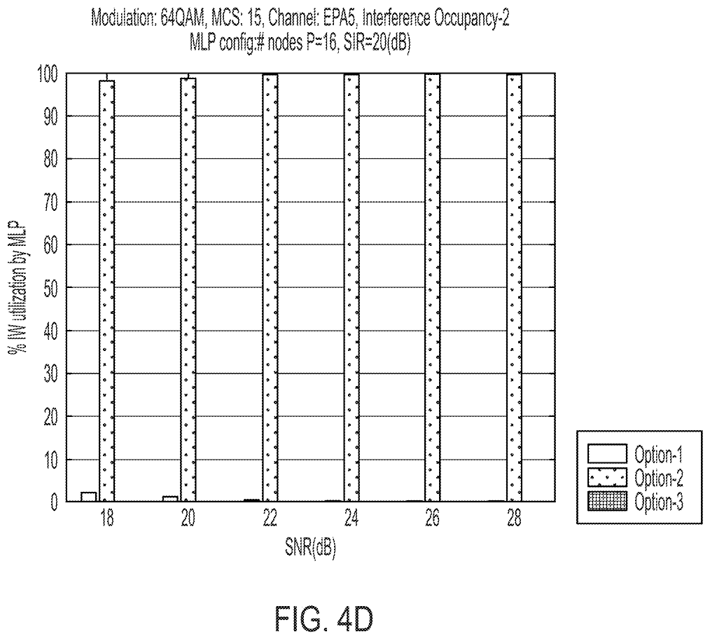

FIGS. 4A through 4D show the simulated performance of a learning-based interference whitening system, according to some embodiments. Results are shown (i) in FIGS. 4A and 4B for a signal BWP of 50 RBs with interference uniformly distributed in the signal BWP (a circumstance referred to herein as “Interference Occupancy-1”) and (ii) in FIGS. 4C and 4D for a signal BWP of 100 RBs with interference in one RB at the center of the BWP (a circumstance referred to herein as “Interference Occupancy-2”).

The block error rate achieved using learning-based interference whitener selection is shown in FIGS. 4A and 4C, and the utilization of the interference whitening method options by the learning-based selection method is shown in FIGS. 4B and 4D. It may be seen that the Option-3 method has the lowest block error rate (BLER) in FIG. 4A while the Option-2 method has the lowest BLER in FIG. 4C. The learning-based interference whitening selection method (i) utilizes these respective methods without requiring any prior knowledge of the interference distribution, the SIR or the SNR and (ii) achieves BLER similar to, or the same as, the best interference whitening method in each case.

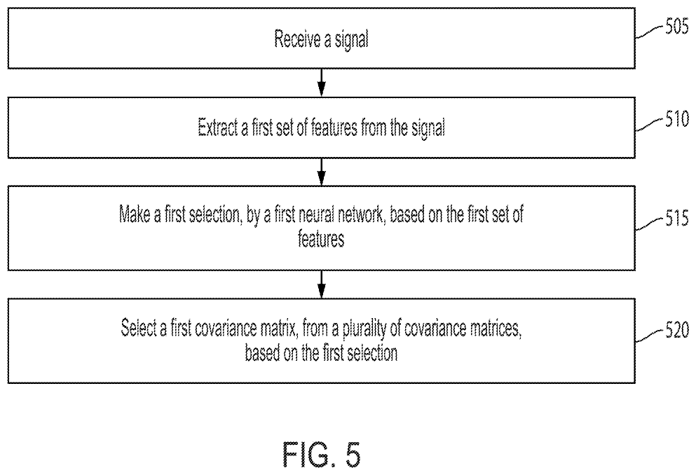

In some embodiments, a processing circuit or means for processing (discussed in further detail below) may perform some or all of the methods described herein. For example, in some embodiments, a UE includes a processing circuit and a radio, and the processing circuit performs the method of FIG. 5, which is a flowchart of a portion of a learning-based method for interference whitening. The method includes, at 505, receiving a signal (by the processing circuit, via the radio); extracting, at 510, a first set of features from the signal; making, at 515, a first selection, by a first neural network, based on the first set of features; and selecting, at 520, a first covariance matrix, from a plurality of covariance matrices, based on the first selection.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, the term “or” should be interpreted as “and/or”, such that, for example, “A or B” means any one of “A” or “B” or “A and B”.

The terms “processing circuit” or “means for processing” are used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a learning-based system and method for interference whitening have been specifically described and illustrated herein, many modifications and variations will be apparent to those skilled in the art. Accordingly, it is to be understood that a learning-based system and method for interference whitening constructed according to principles of this disclosure may be embodied other than as specifically described herein. The invention is also defined in the following claims, and equivalents thereof.

What is claimed is:

1. A method, comprising:
receiving a signal;
extracting a first set of features from the signal;
making a first selection, by a first neural network, based on the first set of features; and
selecting a first covariance matrix, from a plurality of covariance matrices, based on the first selection.

2. The method of claim 1, wherein the making of the first selection by the first neural network comprises making the first selection based on a plurality of initial covariance estimates, each corresponding to a respective resource block (RB) of a contiguous set of resource blocks.

3. The method of claim 2, wherein the contiguous set of resource blocks comprises all of the resource blocks in a bandwidth part.

4. The method of claim 2, further comprising:
extracting a second set of features from the signal; and
making a second selection, by a second neural network, based on the second set of features,
wherein the first set of features corresponds to a first resource block, and the second set of features corresponds to a second resource block.

5. The method of claim 4, wherein:
the first selection is an indication of estimated signal to interference ratio in the first resource block;
the first selection corresponds to a signal to interference ratio less than a first threshold; and
the selecting of the first covariance matrix comprises selecting a covariance matrix based on a first initial covariance estimate, the first initial covariance estimate corresponding to the first resource block.

6. The method of claim 4, wherein:
the first selection is an indication of estimated signal to interference ratio in the first resource block;
the first selection corresponds to a signal to interference ratio greater than a first threshold;
the second selection is an indication of estimated signal to interference ratio in the second resource block;
the second selection corresponds to a signal to interference ratio greater than the first threshold;
the selecting of the first covariance matrix comprises selecting a covariance matrix based on a first initial covariance estimate and on a second initial covariance estimate;
the first initial covariance estimate corresponds to the first resource block; and
the second initial covariance estimate corresponds to the second resource block.

7. The method of claim 1, further comprising calculating a first initial covariance estimate, wherein a first feature of the first set of features is based on the first initial covariance estimate.

8. The method of claim 7, wherein the first feature includes an eigenvalue of the first initial covariance estimate.

9. The method of claim 7, wherein the first feature includes a QR decomposition of the first initial covariance estimate.

10. The method of claim 7, wherein the first feature includes an element of the first initial covariance estimate.

11. A device, comprising:
a radio; and
a processing circuit,
the processing circuit being configured to:
receive, through the radio, a signal;
extract a first set of features from the signal;
make a first selection, by a first neural network, based on the first set of features; and
select a first covariance matrix, from a plurality of covariance matrices, based on the first selection.

12. The device of claim 11, wherein the making of the first selection by the first neural network comprises making the first selection based on a plurality of initial covariance estimates, each corresponding to a respective resource block (RB) of a contiguous set of resource blocks.

13. The device of claim 12, wherein the contiguous set of resource blocks comprises all of the resource blocks in a bandwidth part.

14. The device of claim 12, wherein the processing circuit is further configured to:
extract a second set of features from the signal; and
make a second selection, by a second neural network, based on the second set of features,
wherein the first set of features corresponds to a first resource block, and the second set of features corresponds to a second resource block.

15. The device of claim 14, wherein:
the first selection is an indication of estimated signal to interference ratio in the first resource block;
the first selection corresponds to a signal to interference ratio less than a first threshold; and
the selecting of the first covariance matrix comprises selecting a covariance matrix based on a first initial covariance estimate, the first initial covariance estimate corresponding to the first resource block.

16. The device of claim 14, wherein:
the first selection is an indication of estimated signal to interference ratio in the first resource block;
the first selection corresponds to a signal to interference ratio greater than a first threshold;
the second selection is an indication of estimated signal to interference ratio in the second resource block;
the second selection corresponds to a signal to interference ratio greater than the first threshold;
the selecting of the first covariance matrix comprises selecting a covariance matrix based on a first initial covariance estimate and on a second initial covariance estimate;
the first initial covariance estimate corresponds to the first resource block; and
the second initial covariance estimate corresponds to the second resource block.

17. A device, comprising:
a radio; and
means for processing,
the means for processing being configured to:
receive, through the radio, a signal;
extract a first set of features from the signal;
make a first selection, by a first neural network, based on the first set of features; and
select a first covariance matrix, from a plurality of covariance matrices, based on the first selection.

18. The device of claim 17, wherein the making of the first selection by the first neural network comprises making the first selection based on a plurality of initial covariance estimates, each corresponding to a respective resource block (RB) of a contiguous set of resource blocks.

19. The device of claim 18, wherein the contiguous set of resource blocks comprises all of the resource blocks in a bandwidth part.

20. The device of claim 18, wherein the means for processing is further configured to:
extract a second set of features from the signal; and
make a second selection, by a second neural network, based on the second set of features,
wherein the first set of features corresponds to a first resource block, and the second set of features corresponds to a second resource block.
